(19) United States
(12) Patent Application Publication
(10) Pub. No.: US 2025/0227529 A1
(43) Pub. Date: Jul. 10, 2025

(54) METHOD, USER EQUIPMENT AND ACCESS NETWORK NODE

(71) Applicant: NEC Corporation, Minato-ku, Tokyo (JP)

(72) Inventors: Caroline LIANG, Guildford (GB); Robert ARNOTT, London (GB)

(73) Assignee: NEC Corporation, Minato-ku, Tokyo (JP)

(21) Appl. No.: 18/851,380

(22) PCT Filed: Mar. 22, 2023
(86) PCT No.: PCT/JP2023/011122

§ 371 Date: Sep. 26, 2024

(30) Foreign Application Priority Data
Mar. 31, 2022 (GB) 2204740.1

(51) Int. Cl. H04W 24/10; H04B 17/318; H04W 24/02; H04W 64/00

(52) U.S. Cl. CPC H04W 24/10; H04B 17/328; H04W 24/02; H04W 64/003

(57) ABSTRACT

A system is disclosed in which an access network node (base station) performs channel adaptation of a radio interface between a user equipment (UE) and the radio access network node. The access network node information for determining, by the UE, whether a channel quality of the radio interface has been changed. The access network node receives, from the UE, at a channel quality reporting occasion, a periodic channel quality report including information indicating a current channel quality value, in a case where the UE determined that a current channel quality value of the radio interface has been changed from a previous channel quality value transmitted to the access network node.

### TECHNICAL FIELD

The present disclosure relates to a wireless communication system and devices thereof operating according to the 3rd Generation Partnership Project (3GPP) standards or equivalents or derivatives thereof.

### BACKGROUND ART

The disclosure has particular but not exclusive relevance to improvements relating to channel state feedback in the so-called ‘5G’ or ‘New Radio’ systems (also referred to as ‘Next Generation’ systems).

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and 3GPP TS 37.340 V16.7.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or RAN node is used herein to refer to any such node.

### SUMMARY OF INVENTION

### Technical Problem

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

The Physical Uplink Control Channel (PUCCH) carries a set of information called Uplink Control Information (UCI). The format of the PUCCH depends on what kind of information the UCI carries. The PUCCH format to be used is determined by how many bits of information should be carried and how many symbols are assigned. The UCI used in NR (5G) includes one or more of the following information: Channel State Information (CSI); ACK/NAK; and Scheduling Request (SR). This is generally the same as in LTE (4G), as will be described in more detail hereinafter.

The Physical Downlink Control Channel (PDCCH) carries a set of information called Downlink Control Information (DCI). The DCI used in NR (5G) includes information indicating resource assignment in uplink (UL) or downlink (DL), for a single Radio Network Temporary Identifier (RNTI), e.g. a UE, depending on its Format. There are various DCI formats used in LTE and NR (5G), each of which is a predefined format in which the downlink control information is packed/formed and transmitted in PDCCH. The DCI is used to schedule transmissions from the base station to the UE (downlink) and from the UE to the base station (uplink) and provide such scheduling information to the UE.

In communications, the UE is configured to estimate and report the CSI of a communication channel between the UE and the base station, and this CSI is used in a CSI feedback framework for, amongst other things, enabling appropriate Modulation and Coding Scheme (MCS) selection by the base station based on the channel conditions over all or part of the bandwidth. The MCS defines the number of useful bits that can be carried by one symbol or, more accurately in relation to NR (5G), how many useful bits can be transmitted per Resource Element (RE). MCS depends on radio signal quality in a wireless link, wherein the better the quality of the link, the higher will be the MCS and the more useful bits that can be transmitted within a symbol or RE. The allocated MCS is signalled to the UE using a DCI over the PDCCH, and defines a modulation and code rate. 3GPP TS 38.214 V16.8.0 defines various MCS tables for 5G NR Physical Layer procedures for data.

Generally, NR (similarly to LTE) utilises an implicit rank indicator (RI)/Precoding Matrix Indicator (PMI)/Channel Quality Indicator (CQI) feedback framework for the CSI feedback. Together, a combination of the RI, PMI, and CQI forms a channel-state report, and the CSI feedback framework is “implicit” in the form of CQI/PMI/RI (and Channel Rank Indicator (CRI) in the relevant LTE and NR specifications) derived from a codebook. Rank Indicator (RI) is information relating to a channel rank and indicates the number of streams/layers that can be received via the same time-frequency resource. Since RI is determined by long term fading of a channel, it may be generally fed back at a cycle longer than that of PMI or CQI. PMI Is a value indicating a spatial characteristic of a channel and indicates a precoding matrix index of the network device (base station) preferred by the respective terminal device (UE). CQI is information indicating the strength of a channel and a reception Signal-to-Interference-plus-Noise Ratio (SINR) when the base station uses PMI.

More accurate (or more frequent) CSI feedback allows for more accurate MCS selection and adaptation of the link to the current channel conditions. CSI feedback enhancement to improve link adaptation is beneficial for reliability, and overall system efficiency.

The CSI reporting configuration for CSI can be periodic (P-CSI) using PUCCH, aperiodic (A-CSI) using PUSCH, or semi-persistent (SP-CSI) using PUCCH and DCI-activated PUSCH. In periodic CSI reporting, the reporting time periods (i.e. the time periods defining the reporting points) are determined at a higher layer, using RRC signalling and, at the appropriate junctures, CSI data is transmitted, by the UE to the scheduler (base station), using PUCCH; whereas, in aperiodic reporting, CSI feedback is triggered as required by the base station, using DCI over the PDCCH. In this case, the CSI data is transmitted by the UE over the PUSCH. A-CSI may form the principal CSI feedback framework of a communication system, or it may be a supplementary configuration, and triggered, for example, to deal with a failed detection of P-CSI or SP-CSI reporting.

In order to improve accuracy and allow fast adaptation to changing channel conditions, a relatively small CSI reporting periodicity is needed (resulting in an increased CQI reporting frequency), which leads to increased signalling overhead and increased power consumption. For example, a relatively frequent periodic CSI feedback from the UE to the scheduler may need CQI reporting in every few transmission time intervals (TTIs), even though there may be little (or no) variation in the CQI during certain periods. In other words, there might be periods when the same or a similar CQI value is reported at relatively short intervals. In case of aperiodic CSI feedback, more frequent feedback would require more frequent DCI transmissions from the base station to the UE without any guarantee that changes in channel conditions are detected in a timely manner. Thus, the current CSI feedback approach has a limited use in some situations and it is not ideal for relatively fast link adaptation.

### Solution to Problem

Accordingly, the present disclosure seeks to provide methods and associated apparatus for CSI feedback enhancement to address or at least alleviate (at least some of) the above described issues. There have been some discussions in 3GPP regarding the use of Artificial Intelligence (AI)/Machine Learning (ML) in Release 18 for improving procedures relating to the air interface. One of the possible use cases is CSI feedback enhancement. Accordingly, the present disclosure also seeks to provide methods and associated apparatus based on AI/ML-based CSI feedback enhancements.

In one aspect, the present disclosure provides a method performed by a user equipment (UE) for channel adaptation of a radio interface between the UE and a node of a radio access network, the method comprising: receiving information identifying at least one condition for triggering transmission of a periodic channel quality report; and transmitting, to the radio access network, at a particular channel quality reporting occasion, the periodic channel quality report indicating a current channel quality value, when the at least one condition is met; wherein the information identifies at least one of:
a channel quality change condition identifying a difference needed between the current channel quality value and a previous channel quality value transmitted to the radio access network;
a movement condition identifying a movement needed by the UE for transmitting the periodic channel quality report to the radio access network;
a location condition identifying a location or area where the periodic channel quality report needs to be transmitted to the radio access network;
a location change condition identifying a difference needed between a current location of the UE and a location when transmitting a previous channel quality report to the radio access network; and
a time condition identifying a validity period for a previous channel quality report with the same channel quality value as the current channel quality value.

In one aspect, the present disclosure provides a method performed by a node of a radio access network for channel adaptation of a radio interface between a user equipment (UE) and the node of the radio access network, the method comprising: transmitting information identifying at least one condition for triggering transmission of a periodic channel quality report; and receiving, from the UE, at a particular channel quality reporting occasion, the periodic channel quality report indicating a current channel quality value, when the at least one condition is met; wherein the information identifies at least one of:
a channel quality change condition identifying a difference needed between the current channel quality value and a previous channel quality value transmitted to the radio access network;
a movement condition identifying a movement needed by the UE for transmitting the periodic channel quality report to the radio access network;
a location condition identifying a location or area where the periodic channel quality report needs to be transmitted to the radio access network;
a location change condition identifying a difference needed between a current location of the UE and a location when transmitting a previous channel quality report to the radio access network; and
a time condition identifying a validity period for a previous channel quality report with the same channel quality value as the current channel quality value.

In one aspect, the present disclosure provides a method performed by a node of a radio access network for channel adaptation of a radio interface between a user equipment (UE) and the node of the radio access network, the method comprising: predicting, using an artificial intelligence/machine learning model, at least one variation point for a channel quality value associated with the channel; and transmitting, to the UE, information identifying at least one condition relating to the at least one variation point, for triggering at least one periodic channel quality report by the UE for reporting an actual channel quality value associated with the at least one variation point.

In one aspect, the present disclosure provides a user equipment (UE) for channel adaptation of a radio interface between the UE and a node of a radio access network, the UE comprising: means (for example a memory, a controller, and a transceiver) for receiving information identifying at least one condition for triggering transmission of a periodic channel quality report; and means for transmitting, to the radio access network, at a particular channel quality reporting occasion, the periodic channel quality report indicating a current channel quality value, when the at least one condition is met; wherein the information identifies at least one of:
a channel quality change condition identifying a difference needed between the current channel quality value and a previous channel quality value transmitted to the radio access network;
a movement condition identifying a movement needed by the UE for transmitting the periodic channel quality report to the radio access network;
a location condition identifying a location or area where the periodic channel quality report needs to be transmitted to the radio access network;
a location change condition identifying a difference needed between a current location of the UE and a location when transmitting a previous channel quality report to the radio access network; and
a time condition identifying a validity period for a previous channel quality report with the same channel quality value as the current channel quality value.

In one aspect, the present disclosure provides a node of a radio access network for channel adaptation of a radio interface between a user equipment (UE) and the node of the radio access network, the node comprising: means (for example a memory, a controller, and a transceiver) for transmitting information identifying at least one condition for triggering transmission of a periodic channel quality report; and means for receiving, from the UE, at a particular channel quality reporting occasion, the periodic channel quality report indicating a current channel quality value, when the at least one condition is met; wherein the information identifies at least one of:
a channel quality change condition identifying a difference needed between the current channel quality value and a previous channel quality value transmitted to the radio access network;
a movement condition identifying a movement needed by the UE for transmitting the periodic channel quality report to the radio access network;
a location condition identifying a location or area where the periodic channel quality report needs to be transmitted to the radio access network;
a location change condition identifying a difference needed between a current location of the UE and a location when transmitting a previous channel quality report to the radio access network; and
a time condition identifying a validity period for a previous channel quality report with the same channel quality value as the current channel quality value.

In one aspect, the present disclosure provides a node of a radio access network for channel adaptation of a radio interface between a user equipment (UE) and the node of the radio access network, the node comprising: means (for example a memory, a controller, and a transceiver) for predicting, using an artificial intelligence/machine learning model, at least one variation point for a channel quality value associated with the channel; and means for transmitting, to the UE, information identifying at least one condition relating to the at least one variation point, for triggering at least one periodic channel quality report by the UE for reporting an actual channel quality value associated with the at least one variation point.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 shows schematically a mobile (cellular or wireless) telecommunication system to which embodiments of the disclosure may be applied;

FIG. 2 shows a schematic block diagram of a mobile device forming part of the system shown in FIG. 1;

FIG. 3 shows a schematic block diagram of an access network node (e.g. base station) forming part of the system shown in FIG. 1;

FIG. 4 shows a schematic block diagram of a core network node forming part of the system shown in FIG. 1; and

FIG. 5 shows a schematic illustration of a framework for CSI feedback based on an artificial intelligence/machine learning model.

### DESCRIPTION OF EMBODIMENTS

### Overview

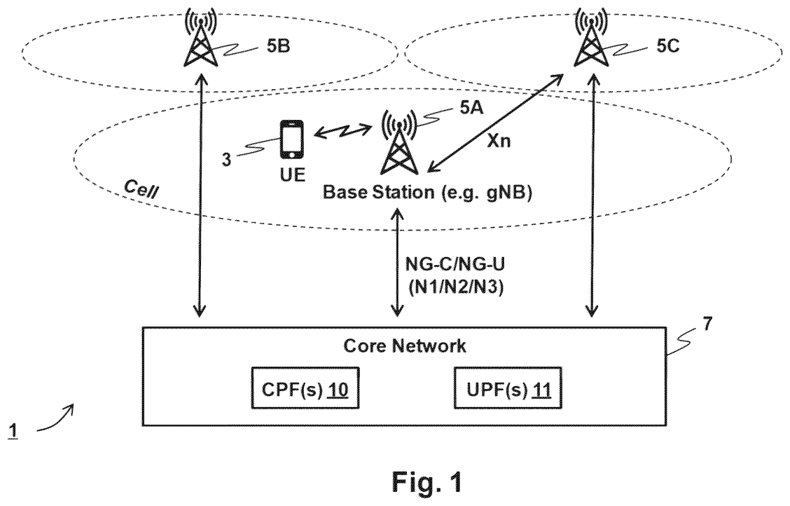

FIG. 1 illustrates schematically a mobile (cellular or wireless) telecommunication system 1 to which embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R)AN. As those skilled in the art will appreciate, whilst one mobile device 3 and three base stations 5A-5C are shown in FIG. 1 for illustration purposes, the system, when implemented, will typically include other base stations/(R)AN nodes and mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. The core network 7 may typically also include an Authentication Server Function (AUSF), a Unified Data Management (UDM) entity, a Policy Control Function (PCF), an Application Function (AF), amongst others. It will be appreciated that the nodes or functions may have different names in different systems. The core network 7 is coupled (via the UPF 11) to a Data Network (DN), such as the Internet or a similar Internet Protocol (IP) based network. The core network 7 may also be coupled to an Operations and Maintenance (OAM) function (not shown).

It will be appreciated that each mobile device 3 may support one or more services which may fall into one of the categories defined above (URLLC/eMBB/mMTC). Each service will typically have associated requirements (e.g. latency/data rate/packet loss requirements, etc.), which may be different for different services.

In this system, the UE 3 is configured to provide periodic CQI feedback relatively frequently (with a relatively small CSI reporting periodicity) to allow fast link adaptation to changing radio conditions on the air interface between the UE 3 and the serving base station 5. However, the UE 3 is also configured with one or more conditions to control whether CQI feedback should be sent at a given reporting occasion. Effectively, the configured condition(s) allow the UE 3 to skip some periodic CQI reports when the report would not result in a change of the link characteristics (e.g. when the CQI to be reported has not changed since the previous report or when a previously transmitted CQI is still considered valid).

This results in a reduction of signalling overhead as the UE 3 is able to skip (or delay) sending of a CQI report (one or more CQI report) when certain conditions are met (at least one condition). Specifically, if the measured CQI does not lead to a CQI level update, the CQI report may not need to be sent to the scheduler (base station 5). For example, in case that the UE 3 is not moving or it does not measure a change in channel condition (or measures a relatively small change, e.g. within an associated threshold), the UE 3 may determine that the associated CQI report is not likely to result in a change of the link configuration used by the base station 5. Thus, in dependence of this determination, at certain CQI reporting occasions, the UE 3 may decide not to transmit a CQI report.

In particular, one or more of the following conditions may be used:
a channel quality change condition identifying a difference needed between the current channel quality (CQI) value and a previous channel quality value transmitted to the radio access network (base station 5);
a movement condition identifying a movement needed by the UE 3 for transmitting the periodic channel quality report to the radio access network;
a location condition identifying a location or area where the periodic channel quality report needs to be transmitted to the radio access network;
a location change condition identifying a difference needed between a current location of the UE 3 and its location when transmitting a previous channel quality report to the radio access network; and
a time condition identifying a validity period for a previous channel quality report with the same (or substantially the same) channel quality value as the current channel quality value.

In another option, Artificial Intelligence (AI)/Machine Learning (ML) is employed for predicting or indicating expected variation points in channel condition, as opposed to an entirely calculation-based channel estimation. Accordingly, the solution may contribute to reduced complexity and improved CQI accuracy. This AI/ML based approach allows adjustment of CSI feedback rate/CSI reporting pattern based on the predicted CSI variation point(s). For example, the UE may be configured to send CSI feedback only upon reaching a significant point of variation (which may be determined by time, location, or distance). Beneficially, the CSI feedback to the base station includes an actual CQI value measured by the UE. This is quite different to other AI/ML based solutions which would predict the CSI from data obtained from other UEs (which may result in a reduced accuracy as the CQI itself is a predicted value rather than a measured value). Conventional periodic CSI reporting would report every several ms, regardless of whether the CQI has changed, or whether the reporting is needed at that point of time or location (e.g. without data traffic).

### User Equipment (UE)

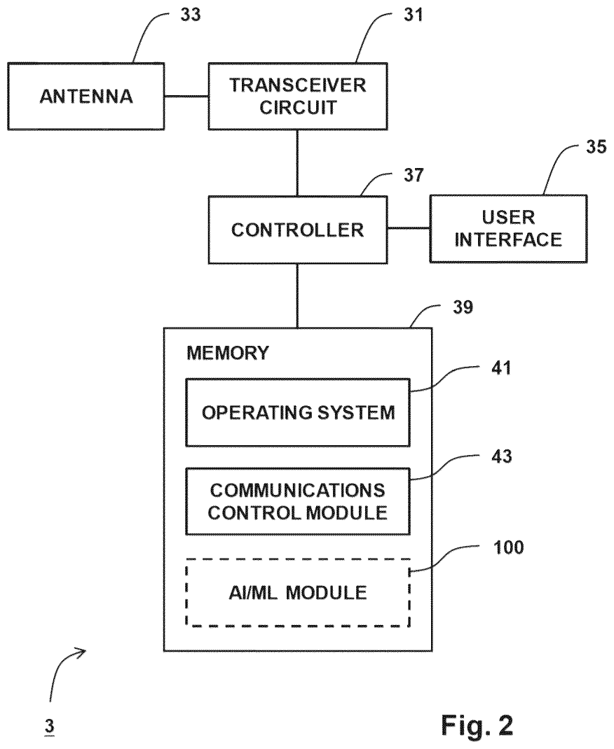

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and AI/ML module 100 (optional).

The communications control module 43 is responsible for handling (generating/sending/receiving) signalling messages and uplink/downlink data packets between the UE 3 and other nodes, including (R)AN nodes 5 and core network nodes. The signalling may comprise control signalling (including UCI and DCI) related to the PUCCH and/or PDCCH (amongst others) and CSI feedback. The communications control module 43 is also responsible for determining the resource sets and codebooks to be used for a particular channel.

If present, the AI/ML module 100 is responsible to perform CQI reporting related processing and signalling based on an appropriate AI/ML model (or algorithm).

### Access Network Node (Base Station)

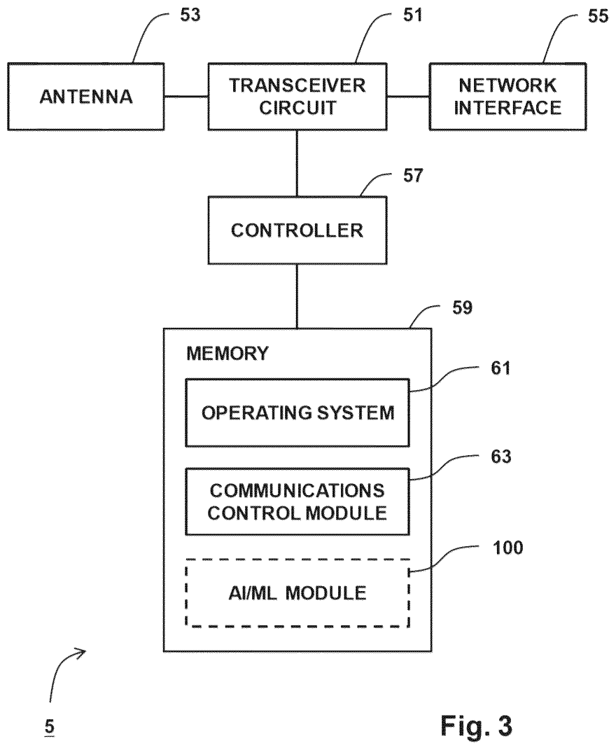

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and AI/ML module 100 (optional).

The communications control module 63 is responsible for handling (generating/sending/receiving) signalling between the base station 5 and other nodes, such as the UE 3 and the core network nodes. The signalling may comprise control signalling (including UCI and DCI) related to the PUCCH and/or PDCCH (amongst others) and CSI feedback. The communications control module 63 is also responsible for determining the resource sets and codebooks for a particular channel.

If present, the AI/ML module 100 is responsible to perform CQI reporting related processing and signalling based on an appropriate AI/ML model (or algorithm).

### Core Network Function

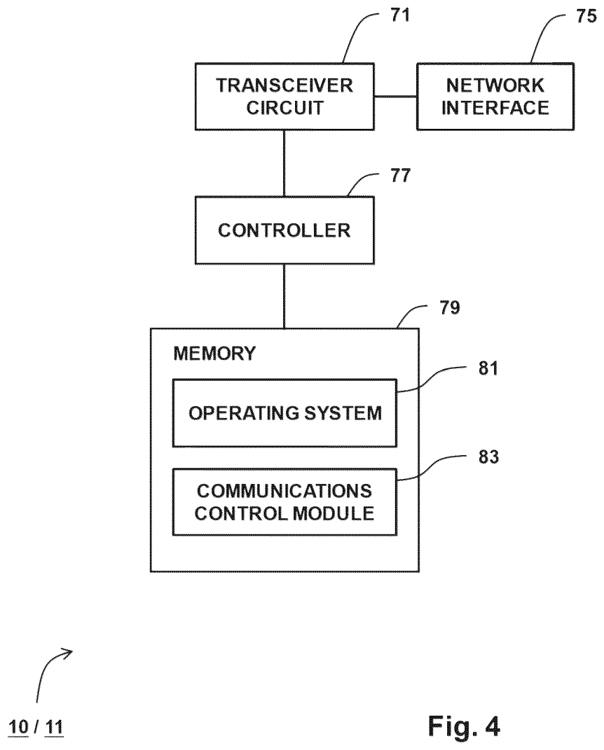

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signaling between the core network function and other nodes, such as the UE 3, the base station 5, and other core network nodes.

### DETAILED DESCRIPTION

In order to improve accuracy and fast adaptation to channel condition, a relatively small CSI reporting periodicity is configured for the UE 3. For example, a periodic CSI (P-CSI) feedback from UE 3 to the scheduler may be sent in every few TTIs. However, in this system, the CSI feedback timing may be autonomously adapted to traffic arrival rate and channel conditions.

In a first example (referred to as ‘Solution 1’), we propose a non-AI/ML based CSI feedback approach. In a second example (referred to as ‘Solution 2’), we propose an AI/ML-based CSI feedback approach for overhead reduction and CQI prediction.

### Solution 1

In this case, the UE 3 (using its communications control module 43) receives information from the serving base station 5 for configuring CQI reporting (for example, via higher layers). The information may include appropriate configuration parameters for periodic CQI reporting (or quasi-periodic CQI reporting). Thus, effectively, the UE 3 is configured to provide CQI reports to the network, with a desired periodicity. It will be appreciated that the periodicity in this case may be relatively low to allow fast link adaptation if necessary.

Beneficially, the UE 3 is also configured to determine whether the sending of a CQI report (one or more CQI report) can be skipped in order to reduce signalling overhead. Specifically, if the measured CQI does not lead to a CQI level update, the CQI report may not need to be sent to the scheduler (base station 5). For example, in case that the UE 3 is not moving or it does not measure a change in channel condition (or measures a relatively small change, e.g. within an associated threshold), the UE 3 may determine that the associated CQI report is not likely to result in a change of the link configuration used by the base station 5. Thus, in dependence of this determination, at certain CQI reporting occasions, the UE 3 may decide not to transmit a CQI report. In this case, in the absence of a current CQI report, the base station 5 may be configured to continue use any previously received (most recent) CQI report (until the UE 3 sends an updated CQI) or employ appropriate processing to predict and apply a new CQI for the UE 3 (without relying on the skipped CQI report). It will also be appreciated that the base station 5 may trigger an aperiodic CQI reporting via DCI when appropriate. For example, the base station 5 may be configured to trigger an aperiodic CQI reporting at a different periodicity than the periodicity applied for the periodic CQI. The base station 5 may also be configured to trigger an aperiodic CQI reporting after failure to receive a certain number of CQI reports have from the UE 3 (e.g. after a total number of skipped/failed CQIs or after a given number of consecutive CQIs).

In summary, the UE 3 will only send the periodic CQI measurement reports to the base station 5 if there is an update in the CQI reporting value. Beneficially, it is possible to employ a relatively low periodicity whilst avoiding the associated signalling overhead when the CQI does not change for a certain period. At the same time, the relatively low periodicity allows fast link adaptation when a sudden CQI change happens since in this case the UE 3 will report the CQI to the base station 5 according to the associated configuration.

In addition, to guard against any missed detection, the following measures may be applied:
1) The UE 3 may be configured with a timer (e.g. CQIValidity Length timer) specifying a time window (from the last transmitted CQI report) during which a CQI can be considered valid. If the timer expires, the UE 3 may be configured to send a new CQI report even if there is no change in the measured CQI (or to send an aperiodic CQI report if requested by the base station 5 upon expiry of the timer).
2) The UE 3 may be configured to update the CQI whenever the UE 3 reaches a certain location or has moved a certain distance from a reference location (e.g. the location of the last CQI report). the UE 3 may be configured to send a new CQI report even if there is no change to the measured CQI.

### Solution 2: (AI/ML Based Solution)

In this solution, Artificial Intelligence (AI)/Machine Learning (ML) is employed for predicting or indicating expected variation points in channel condition, as opposed to an entirely calculation-based channel estimation. Accordingly, the solution may contribute to reduced complexity and improved CQI accuracy. This AI/NL based approach allows adjustment of CSI feedback rate/CSI reporting pattern based on the predicted CSI variation point(s). For example, the UE may be configured to send CSI feedback only upon reaching a significant point of variation (which may be determined by time, location, or distance). Beneficially, the CSI feedback to the base station includes an actual CQI value measured by the UE. This is quite different to other AI/ML based solutions which would predict the CSI from data obtained from other UEs (which may result in a reduced accuracy as the CQI itself is a predicted value rather than a measured value). Conventional periodic CSI reporting would report every several ms, regardless of whether the CQI has changed, or whether the reporting is needed at that point of time or location (e.g. without data traffic).

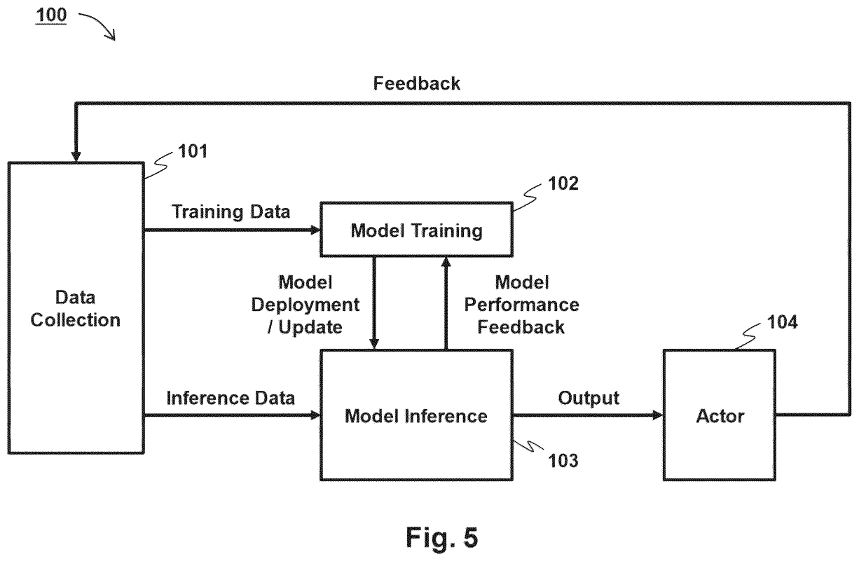

FIG. 5 is a schematic illustration of a framework for CSI feedback based on an AI/ML model. The AI/ML model (or algorithm) may be provided via the AI/ML module 100.

In more detail, the data collection function 101 of the CSI feedback framework provides input data to a model training function 102 and a model inference function 103. Examples of input data may include one or more of: measurements from UEs 3 and/or other network entities; feedback from an actor 104; and output from an AI/ML model. In this example, AI/ML algorithm specific data preparation (e.g. data pre-processing and cleaning, formatting, and transformation) is not carried out in the data collection function 101.

In FIG. 5, the term training data refers to data needed as input for the AI/ML model training function 102, and inference data refers to data needed as input for the AI/ML model inference function 103.

The model training function 102 performs the ML model training, validation, and testing which may generate model performance metrics as part of the model testing procedure. The model training function 102 is also responsible for data preparation (e.g. data pre-processing and cleaning, formatting, and transformation) based on training data delivered by the data collection function 101, if required.

It will be appreciated that the various functions of the AI/ML based CSI feedback framework may be implemented in different nodes. For example, some functions (at least one function) may be provided by the UE 3 and other functions (at least one) may be provided by the base station 5. It will be appreciated that some functions may be implemented in more than one node (e.g. both the UE 3 and the base station 5 may have an associated data collection function 101, or they may be configured to input data to a common data collection function 101).

Beneficially, the above-described AI/ML based framework may be used for CSI feedback enhancement (such as reduction of CSI related overhead, CSI accuracy improvement, and/or CSI prediction). The following is a description of some scenarios in which the use of an AI/ML based framework may be beneficial, along with some exemplary ways of reporting/predicting CQI.

It will be appreciated that a UE 3 may experience periodic or repetitive/repeatable CQI variation, for example, a moving object (mechanical arm or a vehicle with fixed route) in a controlled environment such as in a setting of factory automation. The relative stability and/or limitations of the UE/vehicle movements make it possible to predict future channel variations.

A set of CQI reporting points may be calculated by the base station 5 based on time and/or UE location. The base station 5 may configure a timing set or a location set for each UE 3 (or UE group) following an initial training using the AI/ML model shown in FIG. 5.

In more detail, the UE 3 may be configured with a timing set {t0, t1, t2, t3, t4, . . . , tn} where CSI feedback time tn is configurable within a relatively longer duration than the fixed CQI reporting periodicity. This relatively longer duration may be given by a suitable information element (e.g. timingSetValidity Duration information element) in higher layer signalling (e.g. RRC). When configured with the timing set, the UE 3 reports CQI at the feedback times given by the set.

Similarly, the UE 3 may be configured with a location set {p0, p1, p2, p3, p4, . . . , pn} or a distance set {d0, d1, d2, d3, d4, . . . , dn} where CSI feedback is based on the UE's location pn after a time window or the UE's distance dn travelled within a time window. The time window for the location and the distance may be given by associated information elements (e.g. a locationSetValidity Duration information element and a lengthOfDistance information element) in higher layer signalling (e.g. RRC). It will be appreciated that a significant location or a significant change in location (distance travelled) may represent a significant change in channel condition. When configured with the location set and/or the distance set, the UE 3 reports CQI at the positions given by the set(s).

It will be appreciated that a combined time and location/distance set may be used, where a certain area/location/distance may have an associated timing set (which may be different to the timing set applicable to another area/location/distance).

The base station 5 may derive the applicable time/location/distance set from model training (using its associated AI/ML module 100). The UE 3 knows its own location/distance travelled and/or it may be flagged/notified using AI based positioning for CQI reporting update when the UE 3 reaches each specified point/location or travels a distance corresponding to a value given in the configured set.

Beneficially, the above-described sets may be used to predict or indicate the variation points in channel condition and they may contribute to a reduced complexity and improved CQI accuracy.

### Configuration of CSI Feedback Mode

The CSI feedback mode to be used by the UE 3 may be configurable by RRC signalling (e.g. using an appropriately formatted ‘RRCReconfiguration’ message). For example, the RRC signalling may include an information element to identify the applicable CSI feedback mode {Normal mode, AI-ML-Method1, gNBPredictionMode2, . . . }.

The configuration of CSI feedback mode may include one or more of the following steps:
1) The base station 5 may send the UE 3 an index associated with a CQI timing set selected from a list of CQI update specific timing sets following CQI feedback model training. In this case, the list may be provided via an appropriate information element (e.g. cqiUpdateTimingInfoSets) or a table where each CQI timing set has an associated index.
2) The base station 5 may send the UE 3 an index associated with a CQI location set selected from a list of CQI update specific location sets following CQI feedback model training. In this case, the list may be provided via an appropriate information element (e.g. cqiUpdateLocationInfoSets) or a table where each CQI location set has an associated index.
3) The base station 5 may send the UE 3 an index associated with a distance set selected from a list of CQI update specific distance sets following CQI feedback model training. In this case, the list may be provided via an appropriate information element (e.g. cqiUpdateDistanceSets) or a table where each CQI distance set has an associated index.
4) The base station 5 may need to configure/reconfigure the index of the applicable CQI timing set upon UE location/distance update and/or during peak/off-peak time of traffic arrival in order to further optimise the CQI reporting.
5) The UE 3 will send reduced CQI reporting to the base station 5 according to which index (indices) have been configured for the UE 3.

### Signalling to Support Reduced CSI Feedback

For the CQI timing set, a UE 3 may be provided with a periodic CSI reporting pattern for CQI reporting, via an appropriate information element (e.g. cqi-reportingPattern). Each bit of the pattern corresponds to a normal CQI reporting periodicity with a value of ‘0’ or a value of ‘1’ indicating, respectively, the skipping of CQI reporting or the normal CSI feedback during the validity duration of the CQI reporting pattern.

For the CQI location/distance set, a UE 3 may be provided with a CQI reporting positioning pattern for CQI reporting via an appropriate information element (e.g. cqi-reportingPos). Each bit of the pattern corresponds to a pre-configured significant location/distance, with a value of ‘0’ or a value of ‘1’ indicating, respectively, ‘No change’ or ‘Update’ of the periodic CSI reporting pattern/CQI periodicity.

Note that the time/position/distance may be reset to ‘0’ or the starting point after a configurable time duration, number of positions, or length of distance, and CSI feedback may be skipped if no traffic is expected.

### Signalling to Support Autonomous CSI Feedback

The CQI reporting pattern may be updated autonomously. For example, the CSI feedback pattern may be updated autonomously upon reaching a significant point of variation (which may be determined for example by time, location, and/or distance), based on a trained/configured/reconfigurable location/distance set index and an associated timing set index. Table 1 is an exemplary mapping table that may be used for determining an appropriate timing set index for a given location/distance set index.

TABLE 1
CQI reporting pattern mapping

| Location/Distance Set Index | Timing Set Index |
|---|---|
| posInd1 | CQI Timing Set a |
| posInd2 | CQI Timing Set b |
| posInd3 | CQI Timing Set c |
| posInd4 | CQI Timing Set d |
| . . . | . . . |

The CQI reporting periodicity may be updated autonomously. For example, the CQI reporting periodicity may be updated autonomously upon reaching a significant point of variation (determined by time, location, and/or distance), based on a trained/configured/reconfigurable CQI periodicity and an associated location/distance set. Table 2 is an exemplary mapping table that may be used for determining an appropriate location/distance set for a given CQI periodicity.

TABLE 2
CQI reporting periodicity mapping

| CQI periodicity | Location/Distance Set |
|---|---|
| 2 ms | p0, . . . , pm; d0, . . . , dm |
| 5 ms | pm + 1 . . . , pn; dm + 1, . . . , dn |
| 10 ms | pn + 1, . . . , ps; dn + 1, . . . , ds |
| 20 ms | ps + 1, . . . , pt; ds + 1, . . . , dt |
| . . . | . . . |

### Applying the Concept to ‘Spatial Signature’ or ‘Radio Fingerprint’

It will be appreciated that the above described ‘location’ concept may be expanded to a generalised concept to include the option of ‘spatial signature’ or ‘radio fingerprint’ as an alternative to using the physical location of the UE 3. In this case, ‘fingerprint’ means that a physical location can be identified by the radio conditions at that location.

These could be defined as a learned representation of the physical location based on, for example, reference signal received power (RSRP) or pathloss measurements.

The concept of ‘distance’ (as highlighted in previous slides) between two radio fingerprints could also be defined in different ways. For example, the ‘distance’ can be the difference in RSRP, reference signal received quality (RSRQ), SINR/CQI, or pathloss measurements.

Note that if the radio fingerprint needs to be calculated in the UE 3 then it would require the inference model to be provided to the UE 3.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

It will be appreciated that Solution 1 may be implemented without any AI/ML component. However, at least some aspects of Solution 1 (e.g. CQI validity based on distance or location) may be combined with the AI/ML based approach of Solution 2.

It will be appreciated that the above embodiments may be applied to both 5G New Radio and LTE systems (E-UTRAN).

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary embodiments. It will be appreciated that pre-emption may be handled by the user-plane part of the base station without involving the control-plane part (or vice versa).

The above embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

The information may identify a timing subset of all periodic channel quality reporting occasions configured for the UE, in which case the method performed by the UE may further comprise transmitting, to the radio access network, at a particular channel quality reporting occasion determined by the timing subset, the periodic channel quality report indicating the current channel quality value.

The subset may be identified based on at least one index associated with a respective channel quality report timing value.

The information may identify a specific location, in which case the method performed by the UE may further comprise transmitting, to the radio access network, at the specific location, the periodic channel quality report indicating the current channel quality value.

The specific location may be identified based on an index associated with a respective channel quality reporting location in a set of channel quality reporting locations. The specific location may be identified based on a spatial signature or a radio fingerprint associated with radio conditions at that location.

The information may identify a distance, in which case the method performed by the UE may further comprise transmitting, to the radio access network, the periodic channel quality report indicating the current channel quality value in a case that a difference between the current location of the UE and the location when transmitting a previous channel quality report to the radio access network has reached or exceeded the distance.

The distance may be identified based on an index associated with a respective distance in a set of distances associated with the periodic channel quality report.

The distance may be determined based on at least one of: a difference between respective reference signal received power (RSRP) values, a difference between respective reference signal received quality (RSRQ) values, a difference between respective Signal-to-Interference-plus-Noise Ratio (SINR) values, a difference between respective Channel Quality Indicator (CQI) values, and a difference between respective pathloss measurements, at the current location of the UE and the location when transmitting a previous channel quality report to the radio access network.

The at least one of the information that identifies the timing subset, the information that identifies the specific location, and the information that identifies the distance may be provided via an associated pattern.

The at least one of the timing subset, the specific location, and the distance may be determined using an artificial intelligence/machine learning model.

The at least one of the timing subset, the specific location, the distance, and the at least one condition may be configured via higher layer (e.g. radio resource control) signalling.

The method performed by the node of the radio access network may further comprise receiving, from the UE, at a particular channel quality reporting occasion, the periodic channel quality report indicating a current channel quality value at that reporting occasion, in a case that the at least one condition is met.

The method performed by the node of the radio access network may further comprise: receiving, from the UE, channel quality reports indicating respective channel quality values associated with the channel; and updating, based on the respective channel quality values and using the artificial intelligence/machine learning model, the at least one condition relating to the at least one variation point for triggering at least one further periodic channel quality report by the UE.

The at least one variation point for the channel quality value associated with the channel may be determined by at least one of: an associated time; an associated location; and an associated distance.

The artificial intelligence/machine learning model may include: a data collection function configured to obtain information related to channel quality and information related to the UE, a model training function configured to obtain training data from the data collection function and to obtain model performance feedback, a model inference function configured to provide the model performance feedback to the model training function, and to provide an output based on inference data obtained from the data collection function and based on model deployment/update information obtained from the model training function, and an actor function configured to provide feedback to the data collection function based on the output from the model inference function.

The channel quality report may include at least one of: an implicit rank indicator (RI); a Precoding Matrix Indicator (PMI); and a Channel Quality Indicator (CQI).

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a user equipment (UE) for channel adaptation of a radio interface between the UE and a node of a radio access network, the method comprising:
receiving information identifying at least one condition for triggering transmission of a periodic channel quality report; and
transmitting, to the radio access network, at a particular channel quality reporting occasion, the periodic channel quality report indicating a current channel quality value, when the at least one condition is met;
wherein the information identifies at least one of:
   a channel quality change condition identifying a difference needed between the current channel quality value and a previous channel quality value transmitted to the radio access network;
   a movement condition identifying a movement needed by the UE for transmitting the periodic channel quality report to the radio access network;
   a location condition identifying a location or area where the periodic channel quality report needs to be transmitted to the radio access network;
   a location change condition identifying a difference needed between a current location of the UE and a location when transmitting a previous channel quality report to the radio access network; and
   a time condition identifying a validity period for a previous channel quality report with the same channel quality value as the current channel quality value.

### (Supplementary Note 2)

The method according to supplementary note 1,
wherein the information identifies a timing subset of all periodic channel quality reporting occasions configured for the UE, and
the method further comprises transmitting, to the radio access network, at a particular channel quality reporting occasion determined by the timing subset, the periodic channel quality report indicating the current channel quality value.

### (Supplementary Note 3)

The method according to supplementary note 2, wherein the subset is identified based on at least one index associated with a respective channel quality report timing value.

### (Supplementary Note 4)

The method according to any of supplementary notes 1 to 3,
wherein the information identifies a specific location, and
the method further comprises transmitting, to the radio access network, at the specific location, the periodic channel quality report indicating the current channel quality value.

### (Supplementary Note 5)

The method according to supplementary note 4, wherein the specific location is identified based on an index associated with a respective channel quality reporting location in a set of channel quality reporting locations.

### (Supplementary Note 6)

The method according to supplementary note 4, wherein the specific location is identified based on a spatial signature or a radio fingerprint associated with radio conditions at that location.

### (Supplementary Note 7)

The method according to any of supplementary notes 1 to 6,
wherein the information identifies a distance, and
the method further comprises transmitting, to the radio access network, the periodic channel quality report indicating the current channel quality value in a case that a difference between the current location of the UE and the location when transmitting a previous channel quality report to the radio access network has reached or exceeded the distance.

### (Supplementary Note 8)

The method according to supplementary note 7, wherein the distance is identified based on an index associated with a respective distance in a set of distances associated with the periodic channel quality report.

### (Supplementary Note 9)

The method according to supplementary note 7, wherein the distance is determined based on at least one of:
a difference between respective reference signal received power (RSRP) values,
a difference between respective reference signal received quality (RSRQ) values, a difference between respective Signal-to-Interference-plus-Noise Ratio (SINR) values,
a difference between respective Channel Quality Indicator (CQI) values, and
a difference between respective pathloss measurements, at the current location of the UE and the location when transmitting a previous channel quality report to the radio access network.

### (Supplementary Note 10)

The method according to any of supplementary notes 2 to 9,
wherein at least one of the information that identifies the timing subset, the information that identifies the specific location, and the information that identifies the distance is provided via an associated pattern.

### (Supplementary Note 11)

The method according to any of supplementary notes 2 to 10,
wherein at least one of the timing subset, the specific location, and the distance is determined using an artificial intelligence/machine learning model.

### (Supplementary Note 12)

The method according to any of supplementary notes 1 to 11,
wherein at least one of the timing subset, the specific location, the distance, and the at least one condition is configured via radio resource control signalling.

### (Supplementary Note 13)

A method performed by a node of a radio access network for channel adaptation of a radio interface between a user equipment (UE) and the node of the radio access network, the method comprising:
transmitting information identifying at least one condition for triggering transmission of a periodic channel quality report; and
receiving, from the UE, at a particular channel quality reporting occasion, the periodic channel quality report indicating a current channel quality value, when the at least one condition is met;
wherein the information identifies at least one of:
   a channel quality change condition identifying a difference needed between the current channel quality value and a previous channel quality value transmitted to the radio access network;
   a movement condition identifying a movement needed by the UE for transmitting the periodic channel quality report to the radio access network;
   a location condition identifying a location or area where the periodic channel quality report needs to be transmitted to the radio access network;
   a location change condition identifying a difference needed between a current location of the UE and a location when transmitting a previous channel quality report to the radio access network; and
   a time condition identifying a validity period for a previous channel quality report with the same channel quality value as the current channel quality value.

### (Supplementary Note 14)

A method performed by a node of a radio access network for channel adaptation of a radio interface between a user equipment (UE) and the node of the radio access network, the method comprising:
predicting, using an artificial intelligence/machine learning model, at least one variation point for a channel quality value associated with the channel; and
transmitting, to the UE, information identifying at least one condition relating to the at least one variation point, for triggering at least one periodic channel quality report by the UE for reporting an actual channel quality value associated with the at least one variation point.

### (Supplementary Note 15)

The method according to supplementary note 14, further comprising receiving, from the UE, at a particular channel quality reporting occasion, the periodic channel quality report indicating a current channel quality value at that reporting occasion, in a case that the at least one condition is met.

### (Supplementary Note 16)

The method according to supplementary note 14 or 15, further comprising:
receiving, from the UE, channel quality reports indicating respective channel quality values associated with the channel; and
updating, based on the respective channel quality values and using the artificial intelligence/machine learning model, the at least one condition relating to the at least one variation point for triggering at least one further periodic channel quality report by the UE.

### (Supplementary Note 17)

The method according to any of supplementary notes 14 to 16, wherein the at least one variation point for the channel quality value associated with the channel is determined by at least one of: an associated time; an associated location; and an associated distance.

### (Supplementary Note 18)

The method according to any of supplementary notes 14 to 17, wherein the artificial intelligence/machine learning model includes:
a data collection function configured to obtain information related to channel quality and information related to the UE,
a model training function configured to obtain training data from the data collection function and to obtain model performance feedback,
a model inference function configured to provide the model performance feedback to the model training function, and to provide an output based on inference data obtained from the data collection function and based on model deployment/update information obtained from the model training function, and
an actor function configured to provide feedback to the data collection function based on the output from the model inference function.

### (Supplementary Note 19)

The method according to any of supplementary notes 1 to 18, wherein the channel quality report includes at least one of: an implicit rank indicator (RI); a Precoding Matrix Indicator (PMI); and a Channel Quality Indicator (CQI).

### (Supplementary Note 20)

A user equipment (UE) for channel adaptation of a radio interface between the UE and a node of a radio access network, the UE comprising:
means for receiving information identifying at least one condition for triggering transmission of a periodic channel quality report; and
means for transmitting, to the radio access network, at a particular channel quality reporting occasion, the periodic channel quality report indicating a current channel quality value, when the at least one condition is met;
wherein the information identifies at least one of:
   a channel quality change condition identifying a difference needed between the current channel quality value and a previous channel quality value transmitted to the radio access network;
   a movement condition identifying a movement needed by the UE for transmitting the periodic channel quality report to the radio access network;
   a location condition identifying a location or area where the periodic channel quality report needs to be transmitted to the radio access network;
   a location change condition identifying a difference needed between a current location of the UE and a location when transmitting a previous channel quality report to the radio access network; and
   a time condition identifying a validity period for a previous channel quality report with the same channel quality value as the current channel quality value.

### (Supplementary Note 21)

A node of a radio access network for channel adaptation of a radio interface between a user equipment (UE) and the node of the radio access network, the node comprising:
means for transmitting information identifying at least one condition for triggering transmission of a periodic channel quality report; and
means for receiving, from the UE, at a particular channel quality reporting occasion, the periodic channel quality report indicating a current channel quality value, when the at least one condition is met;
wherein the information identifies at least one of:
   a channel quality change condition identifying a difference needed between the current channel quality value and a previous channel quality value transmitted to the radio access network;
   a movement condition identifying a movement needed by the UE for transmitting the periodic channel quality report to the radio access network;
   a location condition identifying a location or area where the periodic channel quality report needs to be transmitted to the radio access network;
   a location change condition identifying a difference needed between a current location of the UE and a location when transmitting a previous channel quality report to the radio access network; and
   a time condition identifying a validity period for a previous channel quality report with the same channel quality value as the current channel quality value.

### (Supplementary Note 22)

A node of a radio access network for channel adaptation of a radio interface between a user equipment (UE) and the node of the radio access network, the node comprising:
means for predicting, using an artificial intelligence/machine learning model, at least one variation point for a channel quality value associated with the channel; and
means for transmitting, to the UE, information identifying at least one condition relating to the at least one variation point, for triggering at least one periodic channel quality report by the UE for reporting an actual channel quality value associated with the at least one variation point.

This application is based upon and claims the benefit of priority from Great Britain Patent Application No. 2204740.1, filed on Mar. 31, 2022, the disclosure of which is incorporated herein in its entirety by reference.

### REFERENCE SIGNS LIST

1 MOBILE TELECOMMUNICATION SYSTEM
3 MOBILE DEVICE
5 BASE STATION
7 CORE NETWORK
10 CONTROL PLANE FUNCTIONS (CPFs)
11 USER PLANE FUNCTIONS (UPFs)
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE
100 AI/ML MODULE
101 DATA COLLECTION
102 MODEL TRAINING
103 MODEL INFERENCE
104 ACTOR

What is claimed is:

1-32. (canceled)

33. A method performed by a user equipment (UE) for channel adaptation of a radio interface between the UE and an access network node, the method comprising:
receiving criteria information for determining whether a channel quality of the radio interface has been changed;
determining that a current channel quality value of the radio interface has been changed from a previous channel quality value transmitted to the access network node based on the criteria information; and
transmitting, to the access network node, at one of periodic channel quality reporting occasions, a periodic channel quality report including information indicating the current channel quality value upon the determining.

34. The method according to claim 33, wherein
the criteria information indicates at least one condition that the channel quality of the radio interface has been changed, and
the at least one condition includes at least one of:
a channel quality change condition identifying a difference needed between the current channel quality value and the previous channel quality value transmitted to the access network node;
a movement condition identifying a movement needed by the UE for transmitting the periodic channel quality report to the access network node;
a location condition identifying a location or area where the periodic channel quality report needs to be transmitted to the access network node;
a location change condition identifying a difference needed between a current location of the UE and a location when transmitting a previous channel quality report to the access network node; and
a time condition identifying a validity period for a previous channel quality report with the same channel quality value as the current channel quality value, and
the determining is performed in a case where one of the at least one condition is met.

35. The method according to claim 33, further comprising:
receiving information for identifying a timing subset of all periodic channel quality reporting occasions configured for the UE; and
transmitting, to the access network node, at a channel quality reporting occasion identified by the timing subset, the periodic channel quality report indicating the current channel quality value.

36. The method according to claim 35, wherein
the timing subset is identified based on at least one index corresponding to a channel quality report timing value.

37. The method according to claim 33, further comprising:
receiving information for identifying a specific location of a resource; and
transmitting, to the access network node, at the specific location, the periodic channel quality report indicating the current channel quality value.

38. The method according to claim 37, wherein
the specific location is identified based on an index corresponding to a channel quality reporting location in a set of channel quality reporting locations.

39. The method according to claim 37, wherein
the specific location is identified based on a spatial signature or a radio fingerprint corresponding to radio conditions at the specific location.

40. The method according to claim 33, further comprising:
receiving information for a distance between the current location of the UE and the location when transmitting the previous channel quality report to the access network node; and
transmitting, to the access network node, the periodic channel quality report indicating the current channel quality value in a case that the difference indicated in the location change condition has reached or exceeded the distance.

41. The method according to claim 40, wherein
the distance is identified based on an index corresponding to a distance in a set of distances corresponding to the periodic channel quality report.

42. The method according to claim 40, wherein
the distance is determined based on at least one of:
a difference between respective reference signal received power (RSRP) values,
a difference between respective reference signal received quality (RSRQ) values, a difference between respective Signal-to-Interference-plus-Noise Ratio (SINR) values,
a difference between respective Channel Quality Indicator (CQI) values, and
a difference between respective pathloss measurements, at the current location of the UE and the location when transmitting a previous channel quality report to the access network node.

43. The method according to claim 35, wherein
at least one of the information for identifying the timing subset, the information for identifying the specific location, and the information for identifying the distance is provided via a communication pattern.

44. The method according to claim 35, wherein
at least one of the timing subset, the specific location, and the distance is determined using an artificial intelligence/machine learning model.

45. The method according to claim 33, wherein
at least one of the timing subset, the specific location, the distance, and the at least one condition is configured via radio resource control signalling.

46. The method according to claim 33, wherein
the criteria information for determining whether a channel quality of the radio interface is configured by predicting, by the access network node, using the artificial intelligence/machine learning model, at least one variation point for a channel quality value of the radio interface.

47. The method according to claim 46, wherein
the criteria information is updated by the access network node, based on the channel quality value and the artificial intelligence/machine learning model.

48. The method according to claim 46, wherein
the at least one variation point for the channel quality value is determined by at least one of:
an associated time;
an associated location; and
an associated distance.

49. The method according to claim 46, wherein
the artificial intelligence/machine learning model includes:
a data collection function configured to obtain information related to channel quality and information related to the UE,
a model training function configured to obtain training data from the data collection function and to obtain model performance feedback,
a model inference function configured to provide the model performance feedback to the model training function, and to provide an output based on inference data obtained from the data collection function and based on model deployment/update information obtained from the model training function, and
an actor function configured to provide feedback to the data collection function based on the output from the model inference function.

50. A method performed by an access network node for channel adaptation of a radio interface between a user equipment (UE) and the access network node, the method comprising:
transmitting criteria information for determining, by the UE, whether a channel quality of the radio interface has been changed; and
receiving, from the UE, at one of periodic channel quality reporting occasions, a periodic channel quality report including information indicating a current channel quality value, in a case where the UE determined that a current channel quality value of the radio interface has been changed from a previous channel quality value transmitted to the access network node, based on the criteria information.

51. A user equipment (UE) for channel adaptation of a radio interface between the UE and an access network node, the UE comprising:
at least one memory storing instructions; and
at least one processor configured to process the instructions to:
receive criteria information for determining whether a channel quality of the radio interface has been changed;
determine that a current channel quality value of the radio interface has been changed from a previous channel quality value transmitted to the access network node, based on the criteria information; and
transmit, to the access network node, at a channel quality reporting occasion, a periodic channel quality report including information indicating the current channel quality value.

52. An access network node for channel adaptation of a radio interface between a user equipment (UE) and the access network node, the access network node comprising:
at least one memory storing instructions; and
at least one processor configured to process the instructions to:
transmit criteria information for determining, by the UE, whether a channel quality of the radio interface has been changed; and
receive, from the UE, at one of periodic channel quality reporting occasions, a periodic channel quality report including information indicating a current channel quality value, in a case where the UE determined that a current channel quality value of the radio interface has been changed from a previous channel quality value transmitted to the access network node, based on the criteria information.
